(19) United States
(12) Patent Application Publication
(10) Pub. No.: US 2017/0280093 A1
(43) Pub. Date: Sep. 28, 2017

(54) METHOD AND APPARATUS FOR DEMODULATING TELEVISION ANALOG SIGNAL

(71) Applicants: Le Holdings (Beijing) Co., Ltd., Beijing (CN); Le Shi Zhi Xin Electronic Technology (Tianjin) Limited, Tianjin (CN)

(72) Inventor: Jinsheng XUE, Tianjin (CN)

(21) Appl. No.: 15/250,567

(22) Filed: Aug. 29, 2016

Related U.S. Application Data
(63) Continuation of application No. PCT/CN2016/088359, filed on Jul. 4, 2016.

(30) Foreign Application Priority Data
Mar. 22, 2016 (CN) 201610165458.1

(51) Int. Cl. H04N 5/455

(52) U.S. Cl. CPC H04N 5/455

(57) ABSTRACT

A method and apparatus for demodulating a television analog signal is disclosed. The apparatus includes: a radio frequency receiving module, configured to receive a video signal, the video signal being an analog signal; an AD chip, configured to convert the analog signal into a digital signal via an analog-to-digital conversion, and transmit the digital signal via a digital TS; a USB bridge chip, configured to convert the digital TS into a USB signal; and a primary IC, configured to process the USB signal. According to the present disclosure, video signals in the form of analog signals may be processed, thereby addressing the defect in the related art that digital signals can be only processed.

### CROSS REFERENCE TO RELATED APPLICATIONS

This application is a continuation of International Application No. PCT/CN2016/088359 filed on Jul. 4, 2016, which is based upon and claims priority to Chinese Patent Application No. 201610165458.1, filed before Chinese Patent Office on Mar. 22, 2016 and entitled “METHOD AND APPARATUS FOR DEMODULATING TELEVISION ANALOG SIGNAL”, the entire contents of which are incorporated herein by reference.

### TECHNICAL FIELD

The present disclosure relates to the technical field of television chips, and more particularly, to a method and apparatus for demodulating a television analog signal.

### BACKGROUND

A CPU is a core component for measuring the performance of a computer, and a television also has its CPU. In addition to the liquid crystal panel, the CPU of a television is very important because one major purpose of the television is to display images, and stricter requirements are imposed on display of colors as compared to a display. However, the quality of image display of the television is determined by the television chip.

In the field of smart phones, Qualcomm is a leader for providing processors having excellent performance for mobile phones. With respect to smart televisions, which is running Android system as well, Qualcomm has entered the field of television chips. Many television manufacturers choose Qualcomm as their platform. However, till now, the Qualcomm platform does not support modulation of radio frequency signals.

To solve this problem, the root cause is that a current universal serial bus (USB) bridge chip is not only capable of processing a digital code stream, but also capable of converting the digital code stream into a USB signal and transmitting the signal to a primary integrated circuit (IC) for processing. Therefore, the conventional improvement solution is generally to carry out modulation and demodulation by means of adding external tuner+demo, and the demodulated signal is converted into a USB signal via a chip and then transmitted to the primary IC for processing. However, an analog signal, for example, a composite video broadcast signal (CVBS), still cannot be processed. The CVBS is an extensively used standard, which is also referred to as baseband video. Under this standard, data is transmitted via an analog waveform. A composite video includes chromatic aberration (hue and saturation) and luminance (brightness) information, which are synchronized in a blanking impulse, and transmitted over the same signal.

Therefore, the conventional improved technical solution at least has the following problems:

1. Only digital signals are supported. Users in China can only watch digital channels while using cabled signals for example. Analog channels and broadcast signals cannot be used. Therefore, great inconvenience is caused to the users.

2. Most users are accustomed to watching television programs by using a set-top box. The set-top box is connected to an audio video (AV) port via a signal line, wherein the CVBS signal cannot be used.

### SUMMARY

The present disclosure provides a method and apparatus for demodulating a television analog signal, which are capable of processing video signals in the form of analog signals, thereby addressing the defect in the related art that digital signals can be only processed.

An embodiment of the present disclosure provides an apparatus for demodulating a television analog signal, including:

a radio frequency receiving module, configured to receive a video signal, the video signal being an analog signal;

an AD chip, configured to convert the analog signal into a digital signal via an analog-to-digital conversion, and transmit the digital signal via a digital TS;

a USB bridge chip, configured to convert the digital TS into a USB signal; and

a primary IC, configured to process the USB signal.

An embodiment of the present disclosure provides a method for demodulating a television analog signal, including:

receiving a video signal, the video signal being an analog signal;

converting the analog signal into a digital signal via an analog-to-digital conversion, and transmitting the digital signal via a digital TS; and

converting the digital TS into a USB signal, and processing the USB signal.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic structural diagram illustrating an apparatus for demodulating a television analog signal according to some embodiments of the present disclosure;

FIG. 2 is a schematic diagram illustrating conversion of a radio frequency signal into an intermediate-frequency signal according to some embodiments of the present disclosure;

FIG. 3 is a schematic diagram illustrating a TS packet according to some embodiments of the present disclosure;

FIG. 4 is a schematic diagram illustrating formation of a TS according to some embodiments of the present disclosure;

FIG. 5 is a schematic structural diagram illustrating the apparatus for demodulating a television analog signal when the analog signal is a CVBS signal according to some embodiments of the present disclosure; and

FIG. 6 is a schematic flowchart illustrating a method for demodulating a television analog signal according to some embodiments of the present disclosure.

### DETAILED DESCRIPTION

To make the objectives, technical solutions and advantages of the embodiments of the present disclosure clearer, the technical solutions according to the embodiments of the present disclosure are clearly and thoroughly described with reference to the accompanying drawings of the embodiments of the present disclosure. The described embodiments are merely exemplary ones, but are not all the embodiments of the present disclosure. Based on the embodiments of the present disclosure, all other embodiments derived by persons of ordinary skill in the art without any creative efforts shall fall within the protection scope of the present disclosure.

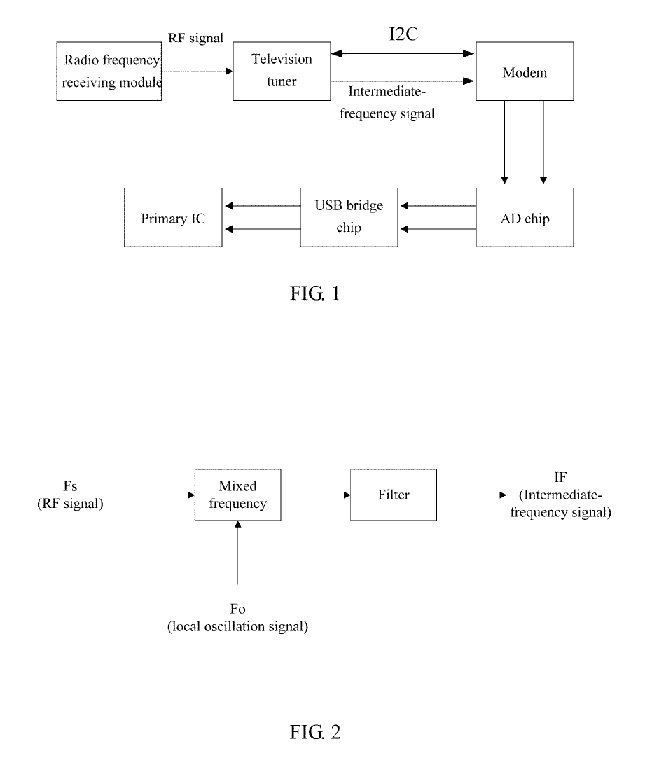

FIG. 1 is a schematic structural diagram illustrating an apparatus for demodulating a television analog signal according to an embodiment of the present disclosure. As illustrated in FIG. 1, the apparatus includes: a radio frequency receiving module, a television tuner, a modem, an AD chip, a USB bridge chip and a primary IC.

The radio frequency receiving module is configured to receive a video signal, the video signal being an analog signal;

Specifically, the radio frequency receiving module receives a video signal via a wired transmission mode or a wireless transmission mode, wherein the video signal is an analog signal.

The analog signal refers to information represented by a constantly changing physical quantity, and signal amplitude or frequency or phase thereof is constantly changing with time, for example, an audio signal or image signal or the like in the current broadcasting.

The radio frequency receiving module modulates the analog signal to a radio frequency signal (RF signal), and then transmits the RF signal to the television tuner.

The television tuner is configured to receive the radio frequency signal transmitted by the radio frequency receiving module, and convert the radio frequency signal into an intermediate-frequency signal and send the intermediate-frequency signal to a modem.

Specifically, the television tuner may be a tuner chip, and the tuner chip receives the radio frequency signal transmitted by the radio frequency receiving module and converts the radio frequency signal into an intermediate-frequency signal.

As illustrated in FIG. 2, the radio frequency signal may be converted into the intermediate-frequency signal based on:

IF=|Fo−Fs|,

In the above equation, IF represents an intermediate-frequency signal output by the television tuner, Fo represents a local oscillation, and Fs represents an input radio frequency signal.

The modem is configured to receive the intermediate-frequency signal transmitted by the television tuner, and perform modulation and demodulation for the intermediate-frequency signal and transmit the signal to the AD chip.

Specifically, the modulation is a process of converting a baseband signal into a digital modulation signal suitable for transmission over a channel, and recovering the received digital frequency band signal into the digital baseband signal. In this embodiment, the modem demodulates the intermediate-frequency signal, converts the demodulated intermediate-frequency signal to the baseband, and decodes the coded signal in the baseband.

The AD chip is configured to convert the intermediate-frequency signal experiencing modulation and demodulation into a digital signal via AD conversion, and transmit the digital signal to the USB bridge chip in the form of digital transport stream (TS).

Specifically, the AD conversion is analog-to-digital conversion. In this embodiment, the intermediate-frequency signal experiencing modulation and demodulation is converted into the digital signal, and the digital signal converted by the AD chip is transmitted to the USB bridge chip in the form of digital TS.

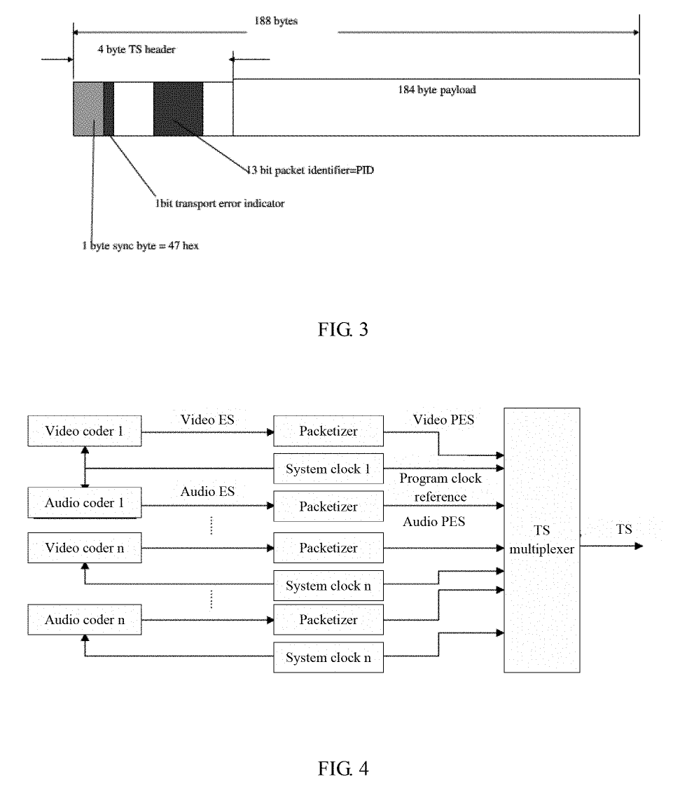

As illustrated in FIG. 3, a TS packet is partitioned, based on functionality, into a link header, an adaptation field and a payload, wherein the link header has a length of 4 bytes, the adaptation field has a variable length of from 0 to 184 bytes, and the payload data has a variable length of from 0 to 184 bytes. The TS is formed by periodical arrangement of a plurality of TS packets having a length of 188 bytes.

The generation process of a TS is as illustrated in FIG. 4. A video elementary stream (ES) and an audio ES form a program elementary stream (PES) via a packager and a shared or independent system time reference, and a transport stream is formed via multiplexing using a TS multiplexer. The ES is a basic code stream, and is a contiguous code stream formed of non-segmented audio, video or other information. The PES stream is packetized basic code stream formed by segmenting a basic ES and adding the corresponding header file and packetizing the segmented basic ES. The TS is a single data stream formed by a combination of one or a plurality of PESs having a shared time reference or an independent time reference.

The USB bridge chip is configured to receive the digital TS transmitted by the AD chip, and convert the digital TS into a USB signal and transmit the USB signal to the primary IC.

Specifically, the USB bridge chip is capable of processing digital code streams. Upon receiving the digital TS, the USB bridge chip converts the digital TS into a USB signal, and then transmits the USB signal to the primary IC for processing.

In the related art, since data signals are only supported, analog signals cannot be processed. In the embodiment of the present disclosure, all the input analog signals are converted into the corresponding TS via the television tuner, the modem and the AD chip. The TS is converted into a digital signal that can be processed by the USB bridge chip via analog-to-digital conversion. That is, the input analog signal is converted into a digital signal, and then the digital signal is processed by the IC. In this way, the defect in the related art that the analog signals cannot be processed is addressed.

In addition, the television tuner and the modem are connected to each other via an inter-IC bus (I2C bus). The I2C bus is a bidirectional double-line continuous bus, and implements data transmission and extension of the peripheral device by using a data line (SDA) and a clock line (SCL), thereby providing a communication line between integrated circuits (ICs). The I2C bus is widely used in televisions, video recorders and audio devices.

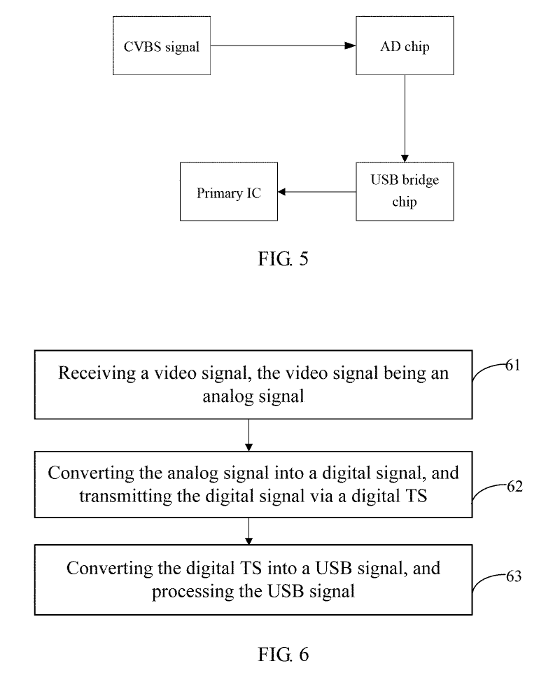

As illustrated in FIG. 5, the apparatus for demodulating a television analog signal according to the present disclosure is further described using a CVBS signal as an example.

The CVBS signal is an analog signal, upon receiving the CVBS signal, the apparatus for demodulating a television analog inputs the received CVBS signal to the AD chip, the AD chip converts the CVBS signal into a digital TS, and transmits the digital TS to the USB bridge chip, and then the digital TS processed by the USB bridge chip is transmitted to the primary IC for processing.

FIG. 6 is a schematic flowchart illustrating a method for demodulating a television analog signal according to an embodiment of the present disclosure. The method is applied to a television, and includes the following steps:

Step S61: A video signal is received, wherein the video signal is an analog signal.

Step S62: The analog signal is converted into a digital signal, and the digital signal is transmitted via a TS.

Step S63: The digital TS is converted into a USB signal, and the USB signal is processed.

To be specific:

A radio frequency receiving module receives a video signal, the video signal being an analog signal.

An AD chip converts the analog signal into a digital signal via an analog-to-digital conversion, and transmits the digital signal via a digital TS.

A USB bridge chip converts the digital TS into a USB signal.

A primary IC processes the USB signal.

In addition, before the AD chip converts the analog signal into the digital signal, the method may further include the following steps:

The radio frequency receiving module receives the analog signal, modulates the analog signal to an RF signal, and then transmits the RF signal to the television tuner.

The television tuner converts the RF signal into an intermediate-frequency signal, and transmits the intermediate-frequency signal to the modem.

The modem performs modulation and demodulation for the intermediate-frequency signal, and then transmits the processed intermediate-frequency signal to the AD chip.

Specifically, the analog signal in the present disclosure may be a CVBS signal.

The specific technical details of the method for demodulating a television analog signal are similar to those of the apparatus for demodulating a television analog signal as described above, which are thus not described herein any further.

In the embodiment of the present disclosure, all the input analog signals are converted into the corresponding TS via the television tuner, the modem and the AD chip. The TS is converted by the USB bridge chip into a digital signal and then transmitted to the primary IC. In this way, the defect in the related art that the analog signals cannot be processed is addressed.

The above described apparatus embodiments are merely for illustration purpose only. The modules which are described as separate components may be physically separated or may be not physically separated, and the components which are illustrated as modules may be or may not be physical modules, that is, the components may be located in the same position or may be distributed into a plurality of network modules. A part or all of the modules may be selected according to the actual needs to achieve the objectives of the technical solutions of the embodiments. Persons of ordinary skill in the art may understand and implement the present disclosure without paying any creative effort.

It should be finally noted that the above-described embodiments are merely for illustration of the present disclosure, but are not intended to limit the present disclosure. Although the present disclosure is described in detail with reference to these embodiments, a person skilled in the art may also make various modifications to the technical solutions disclosed in the embodiments, or make equivalent replacements to a part of the technical features contained therein. Such modifications or replacement, made without departing from the principles of the present disclosure, shall fall within the scope of the present disclosure.

What is claimed is:

1. An apparatus for demodulating a television analog signal, comprising:
a radio frequency receiving module, configured to receive a video signal, the video signal being an analog signal;
an AD chip, configured to convert the analog signal into a digital signal via an analog-to-digital conversion, and transmit the digital signals via a digital TS;
a USB bridge chip, configured to convert the digital TS into a USB signal; and
a primary IC, configured to process the USB signal.

2. The apparatus for demodulating a television analog signal according to claim 1, wherein the radio frequency receiving module modulates the received analog signal to a radio frequency signal.

3. The apparatus for demodulating a television analog signal according to claim 2, further comprising:
a television tuner, configured to receive the radio frequency signal transmitted by the radio frequency receiving module, and convert the radio frequency signal into an intermediate-frequency signal.

4. The apparatus for demodulating a television analog signal according to claim 3, further comprising:
a modem, configured to receive the intermediate-frequency signal transmitted by the television tuner, and perform modulation and demodulation for the intermediate-frequency signal and transmit the signal to the AD chip.

5. The apparatus for demodulating a television analog signal according to claim 1, wherein the analog signal is a CVBS signal.

6. A method for modulating a television analog signal, applied to a television, comprising:
receiving a video signal, the video signal being an analog signal;
converting the analog signal into a digital signal via an analog-to-digital conversion, and transmitting the digital signal via a digital TS; and
converting the digital TS into a USB signal, and processing the USB signal.

7. The method for demodulating a television analog signal according to claim 6, wherein the receiving a video signal comprises: receiving the video signal by a radio frequency receiving module, and modulating the received analog signal to a radio frequency signal.

8. The method for demodulating a television analog signal according to claim 7, further comprising:
receiving, by a television tuner, the radio frequency signal transmitted by the radio frequency receiving module, and converting the radio frequency signal into an intermediate-frequency signal.

9. The method for demodulating a television analog signal according to claim 8, further comprising:
receiving, by a modem, the intermediate-frequency signal transmitted by the television tuner, and performing modulation and demodulation for the intermediate-frequency signal and transmit the signal to an AD chip.

10. The method for demodulating a television analog signal according to claim 9, wherein the AD chip converts the analog signal into a digital signal via analog-to-digital conversion, and transmits the digital signal via a digital TS; a USB bridge chip converts the digital TS into a USB signal; and a primary IC processes the USB signal.
